(19) United States
(12) Patent Application Publication
(10) Pub. No.: US 2016/0306754 A1
(43) Pub. Date: Oct. 20, 2016

(54) STORAGE SYSTEM

(71) Applicant: Kabushiki Kaisha Toshiba, Tokyo (JP)

(72) Inventors: Tsutomu Owa, Kawasaki Kanagawa (JP); Akihiro Suzuki, Kawasaki Kanagawa (JP)

(21) Appl. No.: 14/939,732

(22) Filed: Nov. 12, 2015

Related U.S. Application Data
(60) Provisional application No. 62/148,895, filed on Apr. 17, 2015.

(51) Int. Cl. G06F 12/14

(52) U.S. Cl. CPC G06F 12/1466; G06F 2212/1052

(57) ABSTRACT

According to one embodiment, a storage system includes two connection circuits and two node circuits. The two node circuits are connected with each other. Each of the node circuits includes a first memory and a control circuit. A first memory is configured to store attribute information in which a state of a lock of a resource is recorded. The control circuit is configured to transfer a packet from each connection circuit, and manipulate the attribute information in response to a first packet from each connection circuit.

### CROSS-REFERENCE TO RELATED APPLICATIONS

This application is based upon and claims the benefit of priority from U.S. Provisional Application No. 62/148,895, filed on Apr. 17, 2015; the entire contents of which are incorporated herein by reference.

### FIELD

Embodiments described herein relate generally to a storage system.

### BACKGROUND

Heretofore, there is a technique for sharing a single resource by multiple nodes. For example, a DLM (Distributed lock manager) prevents conflict of access by managing locking of resource. The DLM is executed on each node. It is necessary for the DLM on each node to exchange information about management of locking of resource to and from the nodes.

### BRIEF DESCRIPTION OF THE DRAWINGS

FIG. 1 is a figure for explaining a configuration of a sharing system to which a storage system according to a first embodiment is applied;

FIG. 2 is a flowchart for explaining operation of the first embodiment of each node;

FIG. 3 is a flowchart for explaining operation of the first embodiment of the storage system;

FIG. 4 is a sequence diagram for explaining information transmitted and received by the sharing system according to the first embodiment;

FIG. 5 is a figure for explaining a configuration of a sharing system to which a storage system according to a second embodiment is applied;

FIG. 6 is a flowchart for explaining operation of the second embodiment of each node;

FIG. 7 is a flowchart for explaining operation of the second embodiment of each node;

FIG. 8 is a flowchart for explaining operation of the second embodiment of the storage system;

FIG. 9 is a sequence diagram for explaining information transmitted and received by a sharing system according to the second embodiment;

FIG. 10 is a diagram illustrating a configuration example of a storage system according to a third embodiment;

FIG. 11 is a figure illustrating a configuration example of a CU;

FIG. 12 is a figure for explaining an example of a configuration of a packet; and

FIG. 13 is a figure illustrating a configuration example of an NM.

### DETAILED DESCRIPTION

In general, according to one embodiment, a storage system includes two connection circuits and two node circuits. The two node circuits are connected with each other. Each of the node circuits includes a first memory and a control circuit. A first memory is configured to store attribute information in which a state of a lock of a resource is recorded. The control circuit is configured to transfer a packet from each connection circuit, and manipulate the attribute information in response to a first packet from each connection circuit.

Exemplary embodiments of the storage system will be explained below in detail with reference to the accompanying drawings. The present invention is not limited to the following embodiments.

### First Embodiment

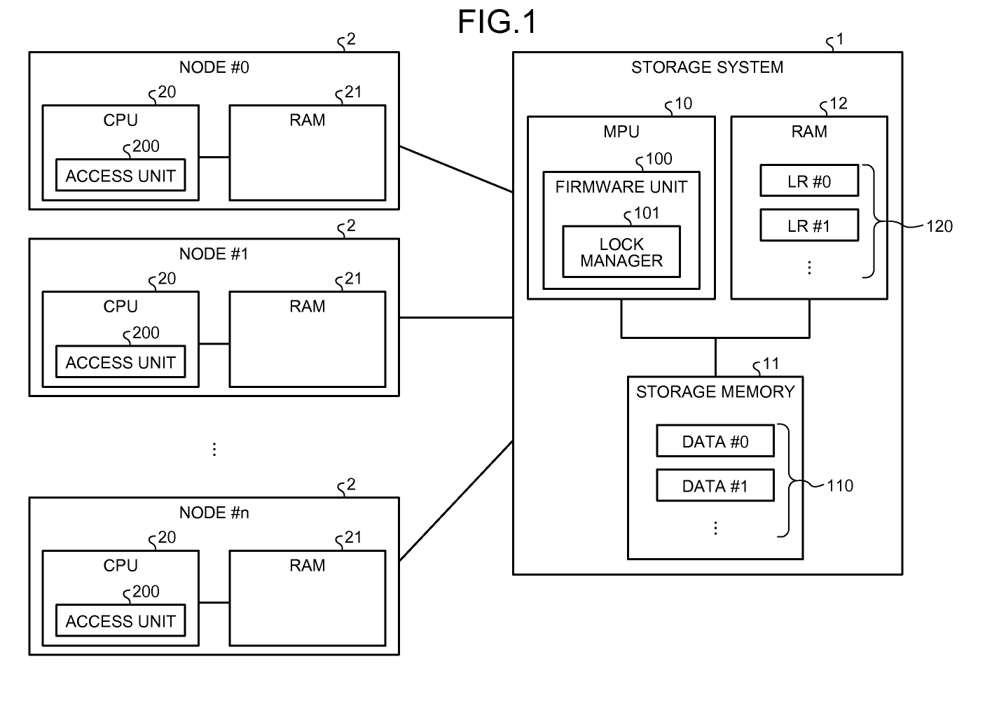

FIG. 1 is a figure for explaining a configuration of a sharing system to which a storage system according to the first embodiment is applied. A sharing system is constituted by a storage system 1 as well as multiple nodes 2. The storage system 1 is connected to the multiple nodes 2. In this case, each of the nodes 2 is distinguished by a number (#0, #1, . . . ) attached after “node”. Any standard may be employed as a standard of a connection interface between the storage system 1 and each node 2.

The storage system 1 may be constituted by a server or may be constituted by a single drive. The storage system 1 can respond to an access command from each node 2. The storage system 1 can transmit and receive information about locking of resource to and from each node 2. The resource to be locked may be any resource. For example, all or a part of the storage area, data, and a processor are included in the concept of the resource to be locked. In the embodiment, for example, data is explained as a resource to be locked. It should be noted that data identified by an address, a file identified by a file name, a database, each record constituting a database, a directory identified by a directory name, and the like are included as a concept of data serving as a resource.

The storage system 1 includes an MPU (Microprocessor) 10, a storage memory 11, and a RAM (Random Access Memory) 12. The MPU 10, the storage memory 11, and the RAM 12 are connected with each other via a bus.

The MPU 10 executes a firmware program to function as a firmware unit 100. More specifically, for example, the MPU 10 loads a firmware program stored in advance in a predetermined nonvolatile storage area (for example, storage memory 11) to the RAM 12 during boot process. Then, the MPU 10 executes the firmware program loaded to the RAM 12 to achieve the function as the firmware unit 100. The firmware unit 100 controls each hardware comprised in the storage system 1 to provide the functions of an external storage device for each node 2. Further, the firmware unit 100 has a lock manager 101. The lock manager 101 executes processing regarding locking of resource.

The storage memory 11 is a nonvolatile memory device. Any type of memory device can be employed as the storage memory 11. For example, a flash memory, a magnetic disk, an optical disk, or a combination thereof may be employed as the storage memory 11. A memory comprising a controller for controlling a physical storage area and a memory not comprising any controller may be employed as the flash memory. The control of the physical storage area includes, for example, control of a bad block, wear levelling, garbage collection, management of corresponding relationship between a physical address and a logical address, and the like. An example of a memory comprising a controller for controlling a physical storage area includes an eMMC (embedded Multi Media Card). In a case where a flash memory not comprising any controller is employed as the storage memory 11, the control of the physical storage area may be executed by the MPU 10. A part of the control of the physical storage area may be executed by the controller in the storage memory 11, and the remaining part of the control of the physical storage area may be executed by the MPU 10.

The storage memory 11 stores one or more data 110 sent from each node 2. In this case, each of the data 110 is distinguished by a number (#0, #1, . . . ) attached after “data”. In the present embodiment, each data 110 is a resource that can be individually locked.

The RAM 12 is a memory device used as a storage area of temporary data by the MPU 10. Any type of RAM can be employed as the RAM 12. For example, a DRAM (Dynamic Random Access Memory), an SRAM (Static Random Access Memory), or a combination thereof may be employed as the RAM 12. Instead of the RAM 12, any type of memory device can be employed as a storage area of temporary data. The RAM 12 stores one or more lock resources (lock resource, LR) 120.

The lock resource 120 is meta-data associated with one of data 110. The lock resource 120 records, as attribute information, the state of the lock of the corresponding data 110. In the first embodiment, at least whether the corresponding data 110 is locked or not and, in a case where the corresponding data 110 is locked, identification information of the node which locked the corresponding data 110 are recorded in the lock resource 120. Accordingly, information indicating “unlocked” and “locked by the node #x” may be recorded in the lock resource 120. The node #x is a node 2 which locked the corresponding data 110. The state that “the data is locked by the node #x” means a state in which “the data can be accessed by only the node #x”. The state of “being unlocked” means a state in which the data can be locked. It should be noted that, when the node #x locks the data 110, this may also be expressed as “the node #x obtains the lock of the data 110”. Manipulation of the lock resource 120 is executed by the lock manager 101. The manipulation includes at least updating of a recorded content. It should be noted that each lock resource 120 is distinguished by a number (#0, #1, . . . ) attached after “lock resource”. The number attached after the “lock resource” is the same as the number for identifying the corresponding data 110. More specifically, the lock resource #x is a lock resource 120 corresponding to the data #x.

Each node 2 includes the same hardware configuration as a computer. More specifically, each node 2 includes at least a processor and a memory device. In this case, each node 2 includes at least a CPU (Central Processing Unit) 20 and a RAM 21. The RAM 21 is a memory device used as a storage area of temporary data by the CPU 20. The CPU 20 is a processor functioning as an access unit 200 on the basis of a program implemented in advance. The access unit 200 can transmit an access command to the storage system 1. The access unit 200 can transmit and receive information about the lock to and from the storage system 1.

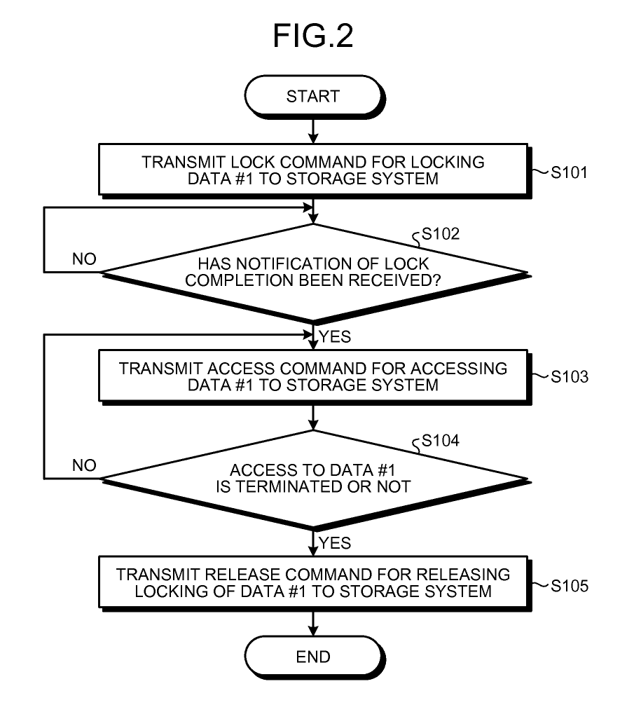

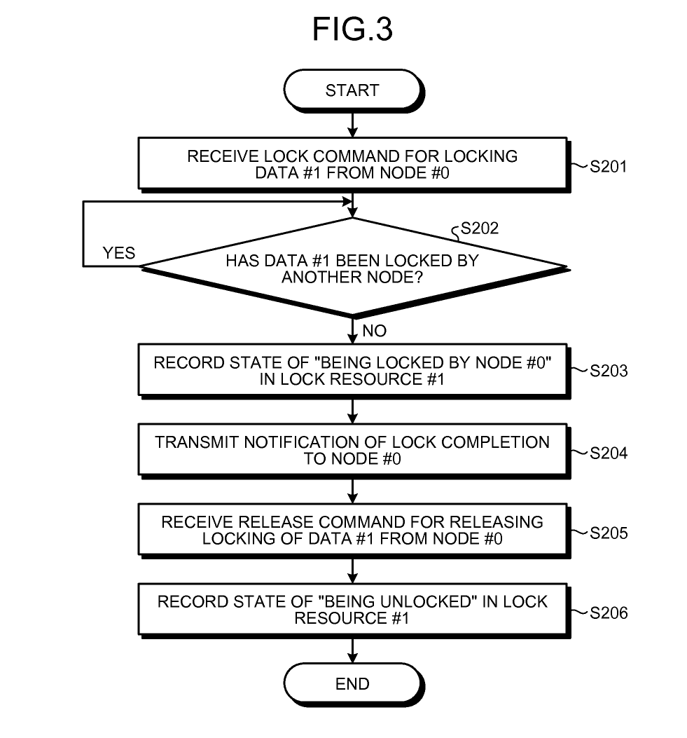

Subsequently, operation of each constituent element will be explained. FIG. 2 is a flowchart for explaining operation of each node 2. FIG. 3 is a flowchart for explaining operation of the storage system 1. It should be noted that the operation of each constituent element when each node 2 accesses any one of the data 110 is the same. In this case, the operation of each constituent element when each node #0 accesses the data #1 will be explained.

As shown in FIG. 2, in the node #0, first, the access unit 200 transmits a lock command for locking the data #1 to the storage system 1 (S101). In the storage system 1, the data #1 is locked in response to the lock command, and thereafter, a notification of lock completion is transmitted to the node #0 (which will be explained later). The access unit 200 determines whether the notification of lock completion has been received or not (S102). When the access unit 200 has not yet received the notification of lock completion (S102, No), processing of S102 is executed again. When the access unit 200 has received the notification of lock completion (S102, Yes), the access unit 200 transmits an access command for accessing the data #1 to the storage system 1 (S103). In FIG. 2, reception of a response in reply to the access command is not shown. The access unit 200 determines whether to terminate access to the data #1 (S104). When the access unit 200 determines not to terminate the access to the data #1 (S104, No), the processing in S103 is executed again. When the access unit 200 determines to terminate the access to the data #1 (S104, Yes), the access unit 200 transmits a release command for releasing the lock of the data #1 to the storage system 1 (S105), thus terminating the operation.

As shown in FIG. 3, in the storage system 1, when the lock manager 101 receives a lock command for locking the data #1 from the node #0 (S201), the lock manager 101 determines whether the data #1 is locked by a node 2 other than the node #0 by referring to the lock resource #1 (S202). When the data #1 is determined to be locked by a node 2 other than the node #0 (S202, Yes), the lock manager 101 executes the processing in S202 again. When the data #1 is not locked by a node 2 other than the node #0 (S202, No), and more specifically, when the data #1 is locked by none of the nodes 2, the lock manager 101 records the state of “being locked by the node #0” in the lock resource #1 in a manner of overwriting (S203). Since the state of “being locked by the node #0” is recorded in the lock resource #1, the lock of the data #1 by the node #0 is completed. The lock manager 101 transmits a notification of lock completion to the node #0 in response to completion of the locking of the data #1 (S204). Thereafter, the lock manager 101 waits for a release command for releasing the locking of the data #1. When the lock manager 101 receives a release command for releasing the locking of the data #1(S205), the lock manager 101 records the state of “being unlocked” in the lock resource #1 in a manner of overwriting (S206), and terminates the operation. As a result of the processing in S206, the state of the data #1 changes from the state of being locked by the node #0 to the state in which the data #1 can be locked by any one of the nodes 2.

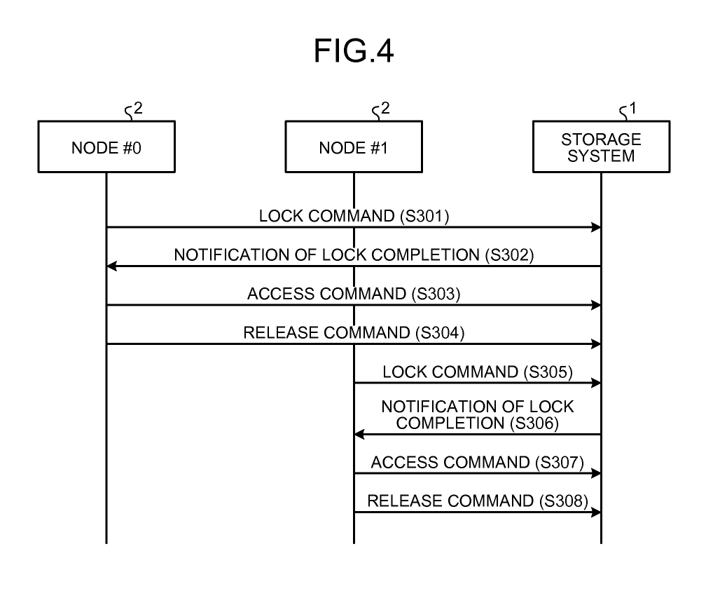

FIG. 4 is a sequence diagram for explaining information transmitted and received between each node 2 and the storage system 1 in the sharing system according to the first embodiment. In the example of FIG. 4, a case where the node #0 accesses the data #1, and thereafter, the node #1 accesses the data #1 will be explained.

First, the node #0 transmits a lock command to the storage system 1 (S301). The storage system 1 transmits a notification of lock completion to the node #0 in response to the lock command (S302). The node #0 transmits an access command to the storage system 1 in response to the notification of lock completion (S303). When the node #0 finishes the access, the node #0 transmits a release command to the storage system 1 (S304).

Subsequently, the node #1 transmits a lock command to the storage system 1 (S305). The storage system 1 transmits a notification of lock completion to the node #1 in response to the lock command (S306). By the way, when the node #1 transmits a lock command in the processing from S302 to S304, the lock manager 101 determines No in S202 in the storage system 1. More specifically, the storage system 1 does not execute the processing in S306 until the processing in S304 is completed. The storage system 1 can execute the processing in S306 after the processing in S304 is completed. The node #1 transmits an access command to the storage system 1 in response to the notification of lock completion (S307). When the node #1 finishes the access, the node #1 transmits a release command to the storage system 1 (S308).

As described above, in the first embodiment, at least two nodes 2 can make connection to the storage system 1. The storage system 1 has a resource that can be used by two nodes 2, and records, to the RAM 12, the lock resource 120 indicating the state of the lock of the resource. The storage system 1 has the lock manager 101 for manipulating the lock resource 120 in response to a command from each node 2. In the case where each node 2 has a DLM, each DLM manages the state of the lock of the resource in synchronization, and therefore, communication between the nodes 2 is indispensable. In contrast, the storage system 1 according to the first embodiment manages the state of the lock of the resource in a central manner on the storage system 1, and therefore, the necessity of communication between the nodes 2 can be eliminated.

The lock manager 101 determines whether the data 120 is locked by a node 2 different from the node 2 of the requester of the locking, on the basis of the lock resource 120. When the data 120 is determined not to be locked by a node 2 different from the node 2 of the requester of the locking, the lock manager 101 records the state of “being locked by the node 2 of the requester of the locking” in the lock resource 120. Therefore, the storage system 1 can lock the resource without needing any communication between the nodes 2.

When the state of “being locked by the node 2 of the requester of the locking” is recorded in the lock resource 120, the lock manager 101 transmits a notification of lock completion to the node 2 of the requester of the locking. The node 2 of the requester of the locking can recognize lock completion by receiving the notification of lock completion. More specifically, the node 2 of the requester of the locking can transmit an access command to the storage system 1 in response to reception of the notification of lock completion.

The node 2 of the requester of the locking can transmit a release command to the storage system 1 in response to transmission of the access command. The lock manager 101 records the state of “being unlocked” in the lock resource 120 in response to reception of a release command. Therefore, the storage system 1 can perform unlocking of the resource without needing any communication between the nodes 2.

The timing of generation of the lock resource 120 and the timing of deletion of the lock resource 120 can be set to any given timing by design. For example, the lock manager 101 may generate a lock resource #x when the firmware unit 100 generates the data #x. The lock manager 101 may be configured to delete the lock resource #x when the firmware unit 100 deletes the data #x. The lock manager 101 may delete the lock resource 120 recorded with the state of “being unlocked”, and may be configured to recognize the state in which the lock resource 120 as the state of “being unlocked”. The lock manager 101 may be configured to generate the lock resource #x in response to reception of a lock command for locking the data #x.

In the above explanation, after transmission of the lock command, the access unit 200 waits for a notification of lock completion, and in response to reception of the notification of lock completion, the access unit 200 transmits an access command. The access unit 200 may wait for a notification of lock completion until a predetermined time-out time elapses after transmission of the lock command, and in a case where the access unit 200 does not receive the notification of lock completion until the predetermined time-out time elapses, the access unit 200 may transmit a lock command again. In a case where the access unit 200 does not receive the notification of lock completion until the predetermined time-out time elapses after transmission of the lock command, the access unit 200 may terminate the processing.

In the above explanation, the data 110 of which locking has been requested is locked by a node 2 different from the node 2 of the requester of the locking, the lock manager 101 waits until locking by the node 2 of the requester of the locking becomes to be able to be done (S202). The lock manager 101 may be configured to transmit a notification indicating that the locking cannot be done to the node 2 of the requester of the locking in the case where the data 110 of which locking has been requested is locked by a node 2 different from the node 2 of the requester. The lock manager 101 may be configured to designate whether to transmit a notification indicating that the locking cannot be done in accordance with a predetermined command from each node 2 (a command option of a lock command and the like) in a case where the locking cannot be done.

The lock manager 101 may be configured to designate a mode of locking. The mode of locking is, for example, designated by a command option of a lock command. The mode of locking includes, for example, a shared lock, an exclusive lock, and the like. The exclusive lock is a mode in which two or more nodes 2 cannot lock the same resource at a time. The lock explained in the first embodiment corresponds to the exclusive lock. The shared lock is a mode in which two or more nodes 2 can lock the same resource at a time. More specifically, in a case where a single node 2 already locks a resource in the mode of shared locking, another node 2 can further lock the resource in the mode of shared locking, but another node 2 cannot lock the resource in the mode of exclusive locking. The node 2 that has locked the resource in the mode of shared locking can execute reading of the resource, but cannot change the resource.

The shared lock can be achieved, for example, as follows. More specifically, the lock resource 120 is recorded with the mode of locking in the case where the corresponding data 110 is locked. The lock resource 120 is recorded with all the nodes 2 that have made locking in the case of the shared lock. The lock manager 101 refers to the corresponding lock resource 120 in a case where the lock command of the shared lock is received from the node #a. Then, the lock manager 101 determines whether the data 110 to be locked has already been locked by another node 2 in the mode of exclusive locking, and whether the data 110 to be locked is locked has already been locked by another node 2 in the mode of shared locking. When the data 110 to be locked is determined to have already been locked by another node 2 in the mode of exclusive locking, the lock manager 101 does not grant locking by the node #a. More specifically, the lock manager 101 does not transmit a notification of lock completion to the node #a. Alternatively, the lock manager 101 transmits a notification indicating that locking cannot be done to the node #a. When the data 110 to be locked is locked by none of the nodes 2 in the mode of exclusive locking, or when the data 110 to be locked is locked by another node 2 in the mode of shared locking, the lock manager 101 grants locking by the node #a. More specifically, the lock manager 101 updates the corresponding lock resource 120, and transmits a notification of lock completion to the node #a. As described above, by changing the determination rule of granting by the lock manager 101, the lock manager 101 can support various kinds of modes of locking.

### Second Embodiment

In the second embodiment, each node 2 has a function of lock caching. The lock caching is a function that, even if the lock is no longer necessary, the lock is not released until another node 2 requests locking.

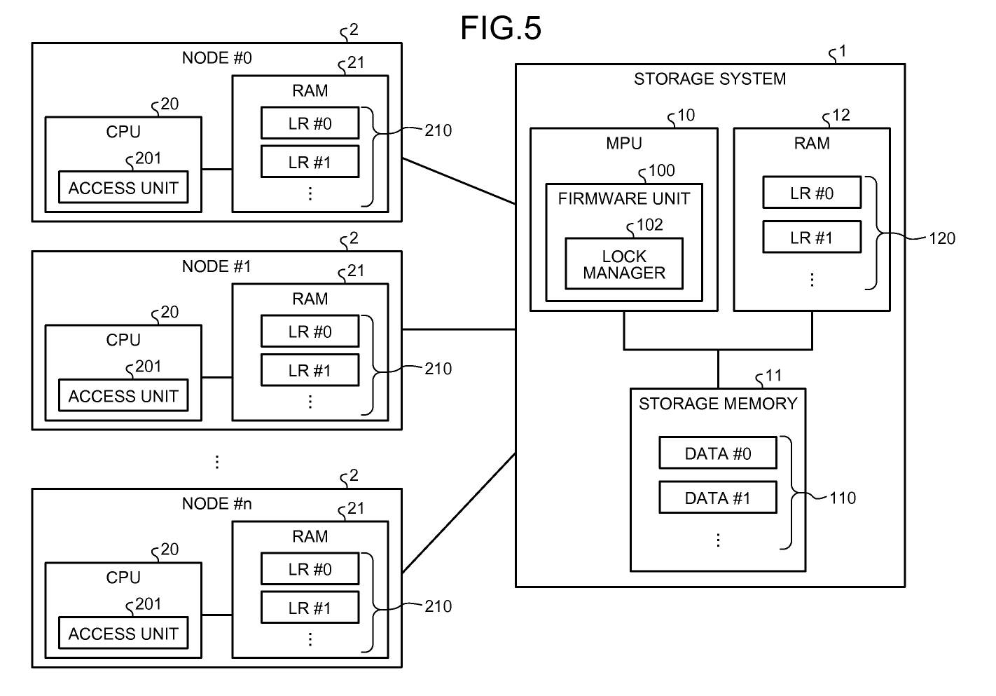

FIG. 5 is a figure for explaining a configuration of a sharing system to which a storage system 1 according to the second embodiment is applied. In this case, the same constituent elements as those of the first embodiment are denoted with the same names and numbers as those of the first embodiment, and repeated explanation thereabout is omitted.

As shown in FIG. 5, the storage system 1 includes an MPU 10, a storage memory 11, and a RAM 12. The MPU 10, the storage memory 11, and the RAM 12 are connected with each other via a bus. The MPU 10 executes a firmware program to function as a firmware unit 100. The firmware unit 100 includes a lock manager 102.

Each node 2 includes a CPU 20 and a RAM 21. The CPU 20 functions as an access unit 201 on the basis of a program implemeted in advance. The RAM 21 stores one or more second lock resources 210. It should be noted that each second lock resource 210 is distinguished by a number (#0, #1, . . . ) attached after “second lock resource”. In the explanation about the second embodiment, the lock resource 120 stored in the RAM 12 is denoted as a first lock resource 120.

The second lock resource 210 is meta-data associated with one of the data 110. More specifically, the second lock resource #0 corresponds to the data #0, and the second lock resource #1 corresponds to the data #1. The state of the lock of the corresponding data 110 is recorded in the second lock resource 210 records as attribute information. A state of “being locked by the own node”, a state of “not being locked by the own node”, and a state of “lock cache” may be recorded in the second lock resource 210. Each state recorded in the second lock resource 210 may be those that can be individually identified. More specifically, the recorded content of the individual state of each state may be any content.

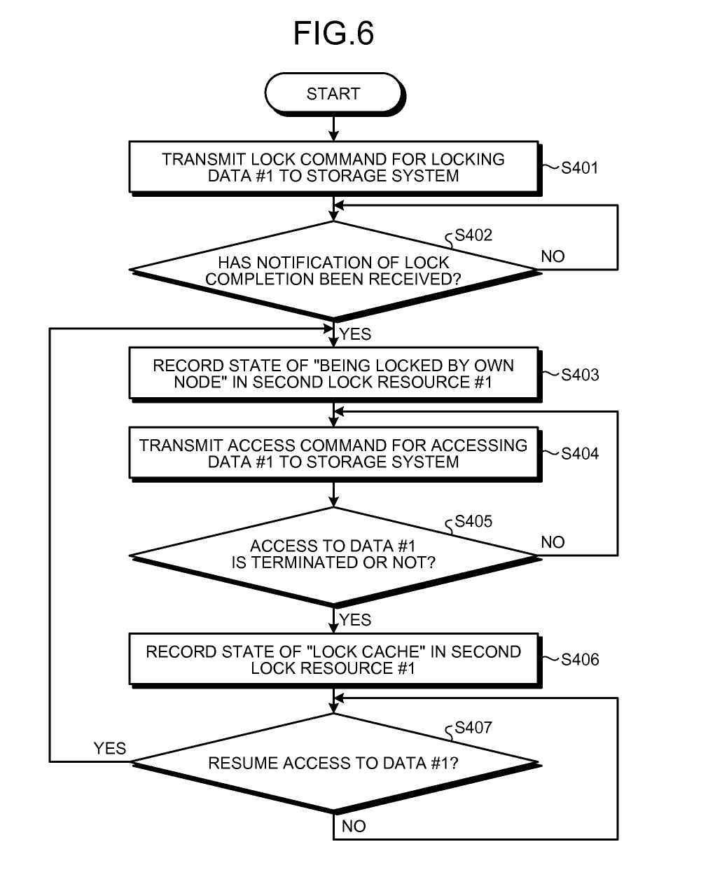

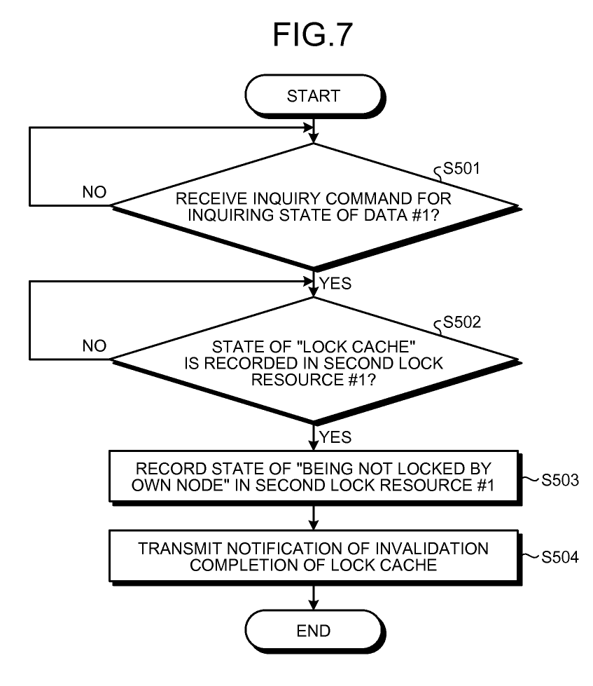

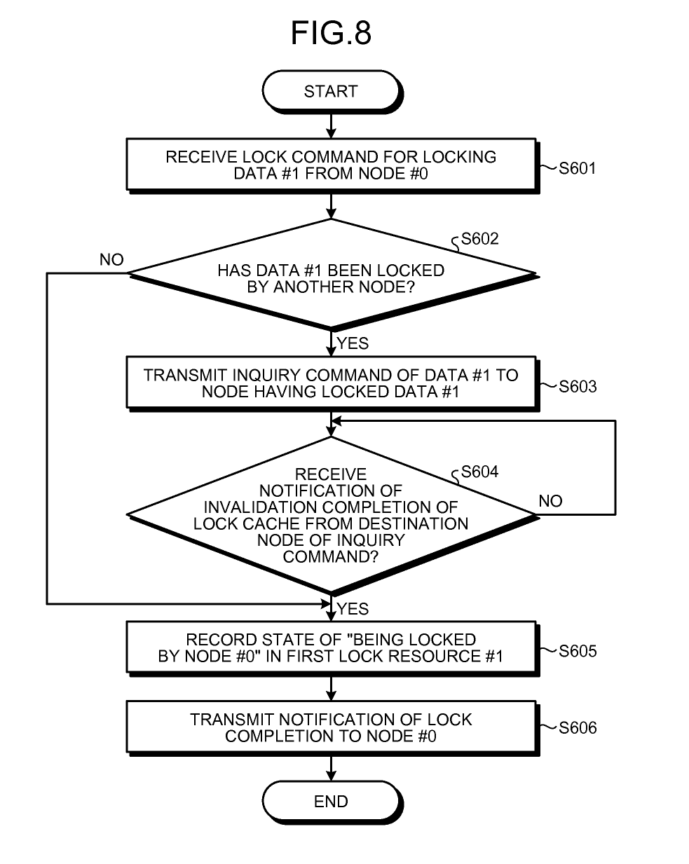

FIGS. 6 and 7 are flowcharts for explaining operation of the second embodiment of each node 2. FIG. 6 illustrates operation concerning locking, and FIG. 7 illustrates operation concerning unlocking. FIG. 8 is a flowchart for explaining operation of the second embodiment of the storage system 1. The operation of each of the nodes 2 is the same. It should be noted that the operation of each constituent element when each node 2 accesses any one of the data 110 is the same. In this case, the operation of each constituent element when each node #0 accesses the data #1 will be explained.

As shown in FIG. 6, in the node #0, first, the access unit 201 transmits a lock command for locking the data #1 to the storage system 1 (S401). Then, the access unit 201 determines whether the notification of lock completion has been received or not (S402). When the access unit 201 has not yet received the notification of lock completion (S402, No), processing of S402 is executed again. When the access unit 201 has received the notification of lock completion (S402, Yes), the access unit 201 records the state of “being locked by the own node” in the second lock resource #1 stored in the own node 2 in a manner of overwriting (S403). The access unit 201 transmits an access command for accessing the data #1 to the storage system 1 (S404). The access unit 201 receives a response in reply to the access command from the storage system 1. The access unit 201 determines whether to terminate access to the data #1 (S405). When the access unit 201 determines not to terminate the access to the data #1 (S405, No), the access unit 201 executes the processing in S404 again. When the access unit 201 determines to terminate the access to the data #1 (S405, Yes), the access unit 201 records the state of “lock cache” in the second lock resource #1 stored in the own node 2 in a manner of overwriting (S406). For example, when the access unit 201 terminates the access to the data #1, the access unit 201 internally issues a release command for releasing the locking of the data #1, and executes the processing in 5406 in response to the issuance of the release command.

After the processing in S406, the access unit 201 determines whether to resume access to the data #1 or not (S407). When the access unit 201 determines to resume access to the data #1 (S407, Yes), the processing in S403 is executed again. When the access unit 201 determines not to resume access to the data #1 (S407, No), the processing in S407 is executed again.

As shown in FIG. 7, the access unit 201 determines whether an inquiry command for inquiring the state of the data #1 has been received from the storage system 1 or not (S501). When the access unit 201 determines that the inquiry command for inquiring the state of the data #1 has not yet been received (S501, No), the processing in S501 is executed again. When the access unit 201 determines that the inquiry command for inquiring the state of the data #1 has been received (S501, Yes), the access unit 201 determines whether the state of “lock cache” is recorded in the second lock resource #1 stored in the own node 2 or not (S502). When the state of “lock cache” is determined not to be recorded in the second lock resource #1 stored in the own node 2 (S502, No), the access unit 201 executes the processing in S502 again. When the state of “lock cache” is determined to be recorded in the second lock resource #1 stored in the own node 2 (S502, Yes), the access unit 201 records the state of “not being locked by the own node” in the second lock resource #1 stored in the own node 2 in a manner of overwriting (S503). Then, the access unit 201 transmits a notification of invalidation completion of a lock cache to the storage system 1 (S504), and terminates the operation.

As shown in FIG. 8, in the storage system 1, when the lock manager 102 receives a lock command for locking the data #1 from the node #0 (S601), the lock manager 102 determines whether the data #1 is locked by a node 2 other than the node #0 by referring to the first lock resource #1 (S602). When the data #1 is determined to be locked by a node 2 other than the node #0 (S602, Yes), the lock manager 102 transmits an inquiry command for inquiring the state of the data #1 to the node 2 that is locking the data #1 (S603). Then, the lock manager 102 determines whether a notification of invalidation completion of the lock cache has been received from the node 2 of the destination of the inquiry command (S604). When the lock manager 102 has not yet received the notification of invalidation completion of the lock cache from the node 2 of the destination of the inquiry command (S604, No), the processing in S604 is executed again. When the lock manager 102 has received the notification of invalidation completion of the lock cache from the node 2 of the destination of the inquiry command (S604, Yes), the lock manager 102 records the state of “being locked by the node #0” in the first lock resource #1 in a manner of overwriting (S605). Then, the lock manager 102 transmits the notification of lock completion to the node #0 (S606), and terminates the operation. When the data #1 is determined not to be locked by a node 2 other than the node #0 (S602, No), the lock manager 102 executes the processing in 5605.

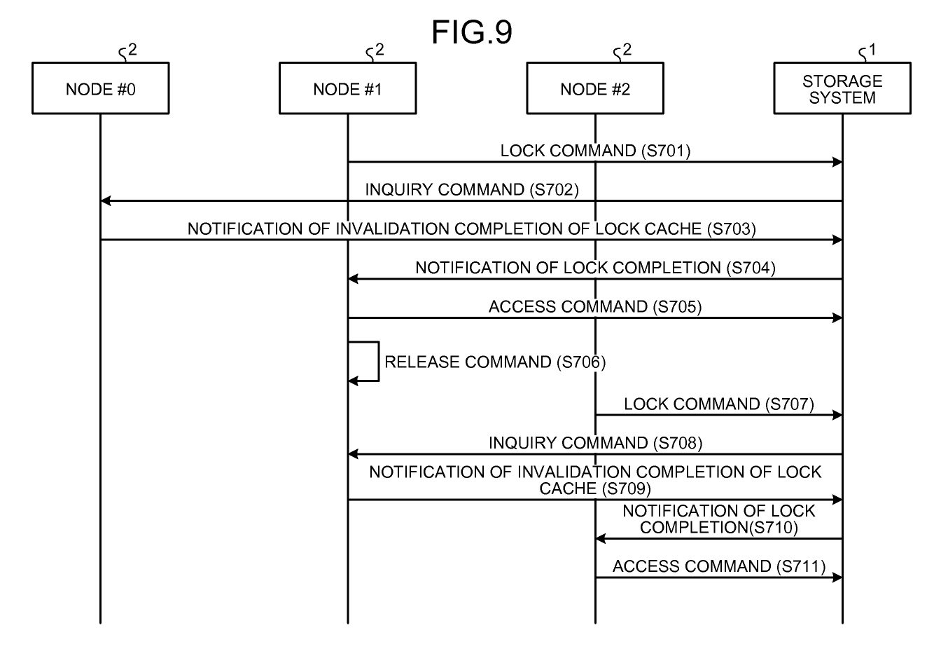

FIG. 9 is a sequence diagram for explaining information transmitted and received in the sharing system according to the second embodiment. In the example of FIG. 9, the following case will be explained: in the state where the node #0 is in the state of “lock cache” with regard to the data #1, the node #1 accesses the data #1, and thereafter, the node #2 accesses the data #1.

First, the node #1 transmits a lock command to the storage system 1 (S701). The storage system 1 transmits an inquiry command to the node #0 in response to the lock command (S702). In response to the inquiry command, the node #0 transmits a notification of invalidation completion of the lock cache to the storage system 1 (S703). In response to the notification of invalidation completion of the lock cache, the storage system 1 transmits a notification of lock completion to the node #1 (S704). In response to the notification of lock completion, the node #1 transmits an access command to the storage system 1 (S705). When the node #1 finishes the access, the node #1 internally executes a release command (S706).

Subsequently, the node #2 transmits a lock command to the storage system 1 (S707). The storage system 1 transmits an inquiry command to the node #1 (S708). The node #1 transmits a notification of invalidation completion of the lock cache to the storage system 1 in response to the inquiry command (S709). In response to the notification of invalidation completion of the lock cache, the storage system 1 transmits a notification of lock completion to the node #2 (S710). In response to the notification of lock completion, the node #2 transmits an access command to the storage system 1 (S711).

As described above, according to the second embodiment, the lock manager 102 transmits an inquiry command to the node 2 that has obtained the lock. In the node 2 to which the inquiry command is transmitted, any one of the state of “being locked by the own node”, the state of “lock cache” and the state of “not being locked by the own node” is recorded in the second lock resource 210. When the state of “lock cache” is recorded in the second lock resource 210, the node 2 to which the inquiry command is transmitted performs manipulation of invalidation of the lock cache, and transmits a notification of invalidation completion of the lock cache to the storage system 1. In response to reception of the notification of invalidation completion of the lock cache, the lock manager 102 performs manipulation of the first lock resource 120. Therefore, the function of the lock cache can be achieved without any communication between the nodes 2.

In response to the reception of a notification of invalidation completion of the lock cache, the lock manager 102 transmits a notification of lock completion to the node 2 of the requester of the locking. In response to reception of the notification of lock completion, the node 2 of the requester of the locking can transmit an access command. Therefore, the function of the lock cache can be achieved without any communication between the nodes 2.

After the access command is transmitted, the node 2 of the requester of the locking records the state of “lock cache” in the second lock resource 210, and thereafter, records the state of “being locked by the own node” in the second lock resource 210, and transmits an access command again to the storage system 1. Therefore, the function of the lock cache can be achieved without any communication between the nodes 2.

The lock manager 102 may be configured to transmit a notification indicating that the lock cannot be done to the node 2 of the requester of the locking when the lock manager 102 transmits an inquiry command to the node 2 that has obtained the lock, and thereafter, the lock manager 102 does not receive a notification of invalidation completion of the lock cache from the node 2 that has obtained the lock in response to the inquiry command. When the node 2 of the requester of the locking receives the notification indicating that the lock cannot be done, the access unit 201 does not transmit an access command.

### Third Embodiment

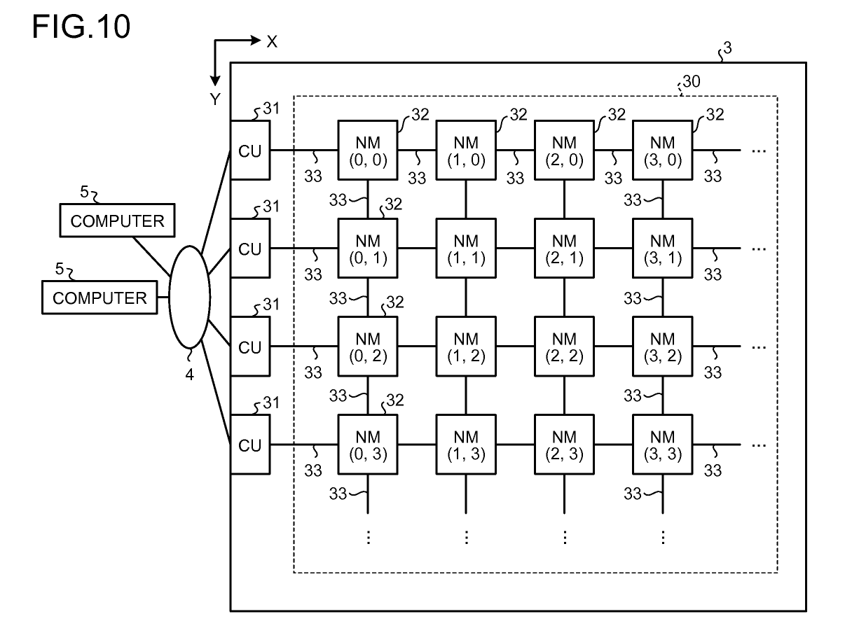

FIG. 10 is a diagram illustrating a configuration example of a storage system 3 according to the third embodiment. The storage system 3 is configured such that one or more computers 5 can make connection via a network 4.

The storage system 3 includes a storage unit 30 and one or more connection units (CU) 31. Each CU 31 corresponds to a connection circuit.

The storage unit 30 has a configuration in which multiple node modules (NM) 32 each having a storage function and a data transfer function are connected via a mesh network. Each NM 32 corresponds to a node circuit. The storage unit 30 stores data to multiple NMs 32 in distributed manner. The data transfer function includes a transfer system according to which each NM 32 efficiently transfers a packet.

FIG. 10 illustrates an example of a rectangular network in which each NM 32 is arranged at a lattice point. A coordinate of a lattice point is represented by a coordinate (x, y), and position information about an NM 32 arranged at a lattice point is represented by a module address (x_{D}, y_{D}) in association with the coordinate of the lattice point. In the example of FIG. 1, the NM 32 located at the upper left corner has a module address (0, 0) of an origin point, and when each NM 32 is moved in a horizontal direction (X direction) and a vertical direction (Y direction), the module address increases in an integer value.

Each NM 32 includes two or more interfaces 33. Each NM 32 is connected with an adjacent NM 32 via an interface 33. Each NM 32 is connected with adjacent NM 32 in two or more different directions. For example, in FIG. 10, an NM 32 indicated by a module address (0, 0) at the upper left corner is connected to an NM 32 represented by a module address (1, 0) adjacent in an X direction and an NM 32 represented by a module address (0, 1) adjacent in a Y direction which is a direction different from the X direction. In FIG. 10, an NM 32 represented by a module address (1, 1) is connected to four NMs 32 respectively indicated by module addresses (1, 0), (0, 1), (2, 1) and (1, 2) which are adjacent in four directions different from each other. Hereinafter, the NM 32 represented by the module address (x_{D}, y_{D}) may be denoted as an NM (x_{D}, y_{D}).

In the example of FIG. 10, each NM 32 is arranged at a lattice point of a rectangular lattice, but the mode of arrangement of each NM 32 is not limited to this example. More specifically, the shape of the lattice may be such that each NM 32 arranged at a lattice point is connected with adjacent NMs 32 in two or more different directions, and, for example, the shape of the lattice may be a triangle, a hexagon, and the like. In FIG. 10, each NM 32 is arranged in a two-dimensional manner, but each NM 32 may be arranged in a three-dimensional manner. When NMs 32 are arranged in a three-dimensional manner, each NM 32 can be designated by three values, i.e., (x, y, z). When the NM 32 is arranged in a two-dimensional manner, the NMs 32 located at the subtenses may be connected with each other, so that the NMs 32 can be connected in a torus shape.

In response to a request received from a computer 5 via the network 4, each CU 31 can execute input and output of data to and from the storage unit 30.

In the example of FIG. 10, the storage system 3 includes four CUs 31. The four CUs 31 are respectively connected to different NMs 32. In this case, each of the four CUs 31 are connected to any one of NM (0, 0), NM (0, 1), NM (0, 2), and NM (0, 3) in a one-to-one relationship. The number of CUs 31 comprised in the storage system 3 may be any number. The CU 31 may be connected to any given NM 32 constituting the storage unit 30. A single CU 31 may be connected to multiple NMs 32. A single NM 32 may be connected to multiple CUs 31. A CU 31 may be connected to any one of multiple NMs 32 constituting the storage unit 30.

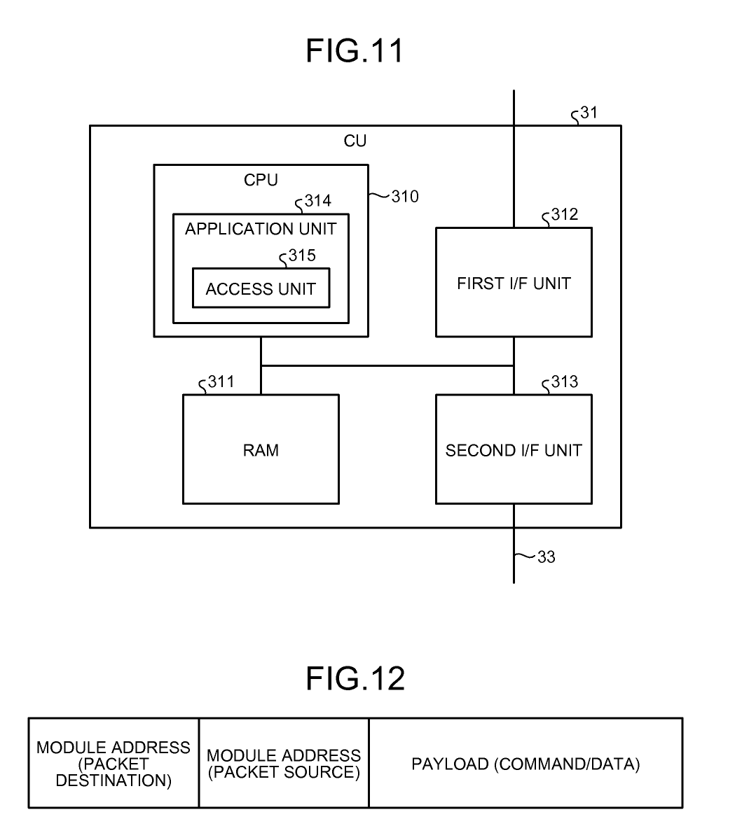

FIG. 11 is a figure illustrating a configuration example of the CU 31. The CU 31 includes a CPU 310, a RAM 311, a first interface (I/F) unit 312, and a second I/F unit 313. The CPU 310, the RAM 311, the first I/F unit 312, and the second I/F unit 313 are connected with each other via a bus. The first I/F unit 312 is provided to connect to the network 4. For example, the first I/F unit 312 may be network interfaces such as Ethernet (registered trademark), InfiniBand, fiber channel, and the like. The first I/F unit 312 may be an external BUS or a storage interface. The first I/F unit 312 may be an external BUS or a storage interface such as, e.g., PCI Express, Universal Serial Bus, Serial Attached SCSI, and the like. The second I/F unit 313 is provided to communicate with the storage unit 30. The second I/F unit 313 may be, for example, a LVDS (Low Voltage Differential Signaling).

The CPU 310 functions as an application unit 314 on the basis of a program implemented in advance. The application unit 314 processes a request from a computer 5 using the RAM 311 as a storage area of temporary data. The application unit 314 is, for example, an application for manipulating a database. The application unit 314 executes access to the storage unit 30 in the processing of an external request.

The application unit 314 includes an access unit 315 for executing access to the storage unit 30. The access unit 315 executes the same operation as the access unit 200 according to the first embodiment. More specifically, the access unit 315 can transmit an access command to the storage unit 30. The access unit 315 can transmit and receive information about lock to and from the storage unit 30. More specifically, the access unit 315 executes operation as shown in FIG. 2. When the access unit 315 accesses the storage unit 30, the access unit 315 generates a packet that the NM 32 can transfer and execute, and transmits the generated packet to the NM 32 connected to the own CU 31.

FIG. 12 is a figure for explaining an example of a configuration of the packet. The packet includes a module address of a recipient's NM 32, a module address of a sender's NM 32, and a payload. A command, data, or both of them are recorded in the payload. Information about the access command and the lock is recorded in the payload of the packet. Hereinafter, the NM 32 of the recipient of the packet is denoted as a packet destination. The NM 32 of the sender of the packet is denoted as a packet source.

A configuration of CUs 31 is not limited as the configuration described above. Each of the CUs 31 may have any configuration as long as each of the CUs 31 is capable of transmitting the packet. Each of the CUs 31 may be composed only of hardware.

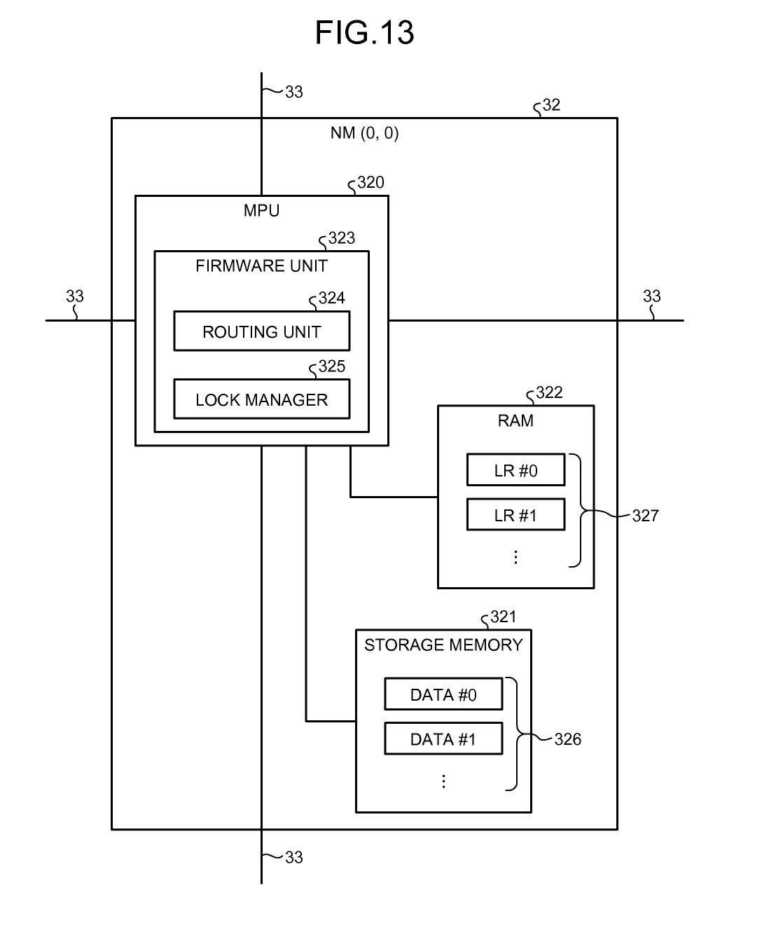

FIG. 13 is a figure illustrating a configuration example of an NM 32. The NM 32 includes an MPU 320 as a control circuit, a storage memory 321, and a RAM 322.

The storage memory 321 is a nonvolatile memory device. Like the storage memory 11 according to the first embodiment, any type of memory device can be employed as the storage memory 321. For example, eMMC is employed as the storage memory 321. The storage memory 321 stores one or more data 326 sent from the CU 31. In this case, the storage memory 321 stores data #0 and data #1 therein.

The RAM 322 is a memory device used as a storage area of temporary data by the MPU 320. Like the RAM 12 according to the first embodiment, any type of RAM can be employed as the RAM 322. The RAM 322 stores one or more lock resources 327 therein. In this case, the RAM 322 stores a lock resource #0 and a lock resource #1. The lock resource 327 is meta-data associated with any data 326 stored in the same NM 32. More specifically, the lock resource #0 corresponds to the data #0, and the lock resource #1 corresponds to the data #1.

In this case, the MPU 320 is connected to four interfaces 33. One end of each interface 33 is connected to the MPU 320, and the other end of each interface 33 is connected to the CU 31 or another NM 32.

The MPU 320 functions as the firmware unit 323 by executing the firmware program. The firmware unit 323 controls each hardware comprised in the NM 32 to provide the storage area for each CU 31. Further, the firmware unit 323 includes a routing unit 324 and a lock manager 325. The lock manager 325 executes the same processing as the lock manager 101 according to the first embodiment. Information about the lock is recorded in the payload of the packet and transmitted.

The routing unit 324 transfers a packet via the interface 33 with the CU 31 or another NM 32 connected to the MPU 310 that executes the routing unit 324. The specification of the interface 33 for connecting between NMs 32 and the specification of the interface 33 connecting an NM 32 and a CU 31 may be different. When the routing unit 324 receives a packet, the routing unit 324 determines whether the packet destination of the received packet is the NM 32 that includes the own routing unit 324. When the destination of the received packet is determined to be the NM 32 that includes the own routing unit 324, the firmware unit 323 executes processing according to the packet (a command recorded in the packet).

The processing according to the command is, for example, what will be explained as follows. More specifically, when a lock command is recorded in a packet, the lock manager 325 executes operation as shown in FIG. 3. When an access command is recorded in a packet, the firmware unit 323 executes access to the storage memory 321 comprised in the NM 32 that includes the own firmware unit 323. The firmware unit 323 transmits a response in reply to a command from the CU 31 in a packet format. More specifically, the response is recorded to the payload of the packet. When the firmware unit 323 generates a packet for response, the packet source recorded in the received packet is set in the packet destination of the packet for response, and the packet destination recorded in the received packet (i.e., the module address of the own NM 32) is set in the packet source of the packet for response. It should be noted that the response to the write command is data. The response to the lock command is, for example, a notification of lock completion.

In a case where the packet destination of the received packet is not the own NM 32, the routing unit 324 transfers the packet to another NM 32 connected to the NM 32 that includes the own routing unit 324.

The routing unit 324 provided in each NM 32 determines a routing destination on the basis of a predetermined transfer algorithm, whereby the packet is successively transferred in one or more NMs 32 to the packet destination. It should be noted that the routing destination is one of other NMs 32 connected, and is an NM 32 that constitutes the transfer route of the packet. For example, the routing unit 324 determines, as the routing destination, an NM 32 located on the route in which the number of transfers from the NM 32 that includes the own routing unit 324 to the packet destination is the minimum from among multiple NMs 32 connected to the NM 32 that includes the own routing unit 324. When there are multiple routes in which the number of transfers from the NM 32 that includes the own routing unit 324 to the packet destination is the minimum, the routing unit 324 selects any one of the multiple routes according to any given method. When the NM 32 which is located on the route in which the number of transfers from the NM 32 that includes the own routing unit 324 to the packet destination is the minimum and which is determined from among multiple NMs 32 connected to the NM 32 that includes the own routing unit 324 is either malfunctioning or busy, the routing unit 324 determines, as the routing destination, another NM 32 chosen from among multiple NMs 32 connected to the NM 32 that includes the own routing unit 324.

To the storage unit 30, there are multiple routes in which the number of transfers is the minimum because multiple NMs 32 are connected and constituted in a mesh network. Even in a case where multiple packets of which a packet destination is a particular NM 32 are issued, the multiple issued packets are transferred in a distributed manner in multiple routes according to the transfer algorithm explained above, and therefore, this can suppress the reduction of the throughput of the entire storage system 3 because of access concentration to the particular NM 32.

Each NM 32 executes management of the lock of the resource that the NM 32 includes, and therefore, it is easy to change the number of NMs 32 provided in the storage system 3. It should be noted that a group may be constituted by a predetermined number of NMs 32, and the storage system 3 may be configured such that one of the predetermined number of NMs 32 which belong to the group manages the resources of the other NMs 32 which belong to the group.

A configuration of the NMs 32 is not limited as the configuration described above. Each of the NMs 32 may have any configuration as long as each of the NMs 32 has a memory such as the storage memory 321 or the RAM 322 and a function of the control circuit. The control circuit may have any configuration as long as the control circuit has a function of transferring the packet from the CUs 31 and a function of manipulating the lock resources 327 in response to the packet from the CUs 31. The control circuit may be composed only of hardware.

As described above, according to the third embodiment, the storage system 3 includes two or more CUs 31 and two or more NMs 32. Each NM 32 is connected with each other in two or more different directions. Each CU 31 executes the operation corresponding to the node 2 according to the first embodiment, and each NM 32 executes the operation corresponding to the storage system 1 according to the first embodiment. Each NM 32 has a function of routing the packet received by the NM 32 to the NM 32 of the destination of the packet. Each NM 32 is connected with each other in two or more different directions, and each NM 32 executes management of the state of the lock of the resource of each of the NMs 32, and executes routing of the packet received by the NM 32, and therefore, the lock of the resource can be done without any communication between the CUs 31.

It should be noted that each CU 31 may be configured to execute the operation corresponding to the node 2 according to the second embodiment, and each NM 32 may be configure to execute the operation corresponding to the storage system 1 according to the second embodiment. More specifically, the access unit 315 may be configured to execute the operation as shown in FIGS. 6 and 7, and the lock manager 325 may be configured to execute the operation as shown in FIG. 8. In that case, the RAM 311 provided in each CU 31 stores the lock resource having the same configuration as the second lock resource 120.

### Fourth Embodiment

The access units 200, 201, 315 may be configured to be able to transmit a command capable of requesting, with a single command, two or more operations chosen from among locking of data, access to data, and release of locking of data.

For example, the access units 200, 201, 315 transmit a command for requesting both of locking of data and access to data (hereinafter referred to as a lock and access command). When the firmware units 100, 323 receive the lock and access command, the lock managers 101, 102, 325 determine whether the locking is granted in the processing of S202, S602, and the like. After the locking is granted, the firmware units 100, 323 execute access to the data. It should be noted that the lock managers 101, 102, 325 may transmit a notification of lock completion in response to grant of locking, or may not transmit a notification of lock completion.

For example, the access units 200, 201, 315 transmit a command for requesting both of access to data and release of locking of data (hereinafter an access and release command). When the firmware units 100, 323 receive the access and release command, the firmware units 100, 323 access the data. After the access to the data is completed and a response of access result is transmitted, the lock managers 101, 102, 325 release the locking of data in the processing in S206. It should be noted that the lock manager 102 may transmit an inquiry command when releasing the locking of the data.

For example, the access units 200, 201, 315 transmit a command for requesting all of the locking of the data, access to the data, and release of the locking of the data (hereinafter referred to as a lock and access and release command). When the firmware units 100, 323 receive the lock and access and release command, the lock managers 101, 102, 325 determine whether the locking is granted in the processing of S202, S602, and the like. After the locking is granted, the firmware units 100, 323 execute access to the data. After the access to the data is completed and a response of access result is transmitted, the lock managers 101, 102, 325 release the locking of data in the processing in S206. It should be noted that the lock managers 101, 102, 325 may transmit a notification of lock completion in response to grant of locking, or may not transmit a notification of lock completion. It should be noted that the lock manager 102 may transmit an inquiry command when releasing the locking of the data.

The lock and access command, the access and release command, and the lock and access and release command may be configured by a command option of an access command.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage system comprising:
two connection circuits; and
two node circuits connected with each other,
wherein each of the node circuits includes:
a first memory configured to store attribute information in which a state of a lock of a resource is recorded; and
a control circuit configured to transfer a packet from each connection circuit, and manipulate the attribute information in response to a first packet from each connection circuit.

2. The storage system according to claim 1, wherein one connection circuit among the two connection circuits transmits the first packet with designation of a first resource,
first control circuit records locking of the first resource by the one connection circuit in first attribute information in response to the first packet,
the first control circuit is the control circuit included in one node circuit among the two node circuits
the first resource is the resource in the one node circuit, and
the first attribute information is the attribute information included in the one node circuit.

3. The storage system according to claim 2, wherein the first control circuit
determines whether the other connection circuit among the two connection circuits locks the first resource or not on the basis of the first attribute information,
in a case where the other connection circuit does not lock the first resource, records locking of the first resource by the one connection circuit in the first attribute information,
in a case where the other connection circuit locks the first resource, does not record locking of the first resource by the one connection circuit in the first attribute information.

4. The storage system according to claim 3, wherein the first control circuit transmits a second packet to the one connection circuit in response to recording locking of the first resource by the one connection circuit in the first attribute information, and
the one connection circuit transmits a third packet for requesting processing of the first resource to the one node circuit in response to receiving the second packet.

5. The storage system according to claim 4, wherein the one connection circuit transmits a fourth packet to the one node circuit in response to transmitting the third packet to the one node circuit, and
the first control circuit records locking of the first resource by none of the two connection circuits in the first attribute information in response to the fourth packet.

6. The storage system according to claim 4, wherein
in a case where the other connection circuit among the two connection circuits locks the first resource, the first control circuit transmits the fourth packet to the one node circuit, and
in a case where the one connection circuit receives the fourth packet, the one connection circuit does not transmit the third packet to the one node circuit.

7. The storage system according to claim 2, wherein
the first control circuit transmits a second packet to the other connection circuit among the two connection circuits in response to receiving the first packet, and thereafter, records locking of the first resource by the one connection circuit in the first attribute information in response to receiving third packet from the other connection circuit.

8. The storage system according to claim 7, wherein each connection circuit stores one of a first state, a second state, and a third state therein,
in a case where the other connection circuit stores the first state therein, the other connection circuit does not transmit the third packet to the one node circuit, and
in a case where the other connection circuit stores the second state therein, the other connection circuit stores the third state therein, and transmits the third packet to the one node circuit.

9. The storage system according to claim 8, wherein the first control circuit transmits the fourth packet to the one connection circuit in response to recording locking of the first resource by the one connection circuit in the first attribute information, and
the one connection circuit stores the first state therein in response to receiving the fourth packet, and transmits a fifth packet for requesting processing of the first resource to the one node circuit in response to storing of the first state.

10. The storage system according to claim 9, wherein the one connection circuit stores the second state therein after transmission of the fifth packet, and thereafter, stores the first state therein, and transmits a sixth packet for requesting processing of the first resource to the one node circuit in response to storing of the first state.

11. The storage system according to claim 9, wherein
in a case where the first control circuit does not receive the third packet from the other connection circuit in response to the second packet, the first control circuit transmit a sixth packet to the one connection circuit,
in a case where the one connection circuit receives the sixth packet, the one connection circuit does not store the first state therein.

12. The storage system according to claim 4, wherein each node circuit further includes a processing circuit for executing processing requested by the third packet, and
the first control circuit records locking of the first resource by none of the two connection circuits in the attribute information in response to completing processing requested by the third packet.

13. The storage system according to claim 1, wherein each node circuit includes a nonvolatile second memory,
wherein the resource is data stored in the second memory.

14. The storage system according to claim 1, wherein a packet from the two connection circuit includes a destination address, and
the control circuit
determines whether a destination of a received packet is a node circuit that includes the own control circuit on the basis of the destination address,
in a case where the destination of the received packet is not the node circuit that includes the own control circuit, the control circuit transfers the received packet to a node circuit connected to the node circuit that includes the own control circuit.

15. A storage system connectable to two nodes, the storage system comprising:
a memory configured to store attribute information including the state of the lock of a resource which is capable of being used by the two nodes; and
a control circuit configured to manipulate the attribute information in response to a command from each node.
